(19) United States
(12) Patent Application Publication
(10) Pub. No.: US 2009/0028051 A1
(43) Pub. Date: Jan. 29, 2009

(54) DATA SERVICE SEQUENCING USING ORDERING THEORIES

(75) Inventors: Eric Dyke, Montreal (CA); Stephane Lessard, Mirabel (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/829,190

(22) Filed: Jul. 27, 2007

(51) Int. Cl. G08C 15/00

(52) U.S. Cl. 370/237

(57) ABSTRACT

Methods and apparatus for determining a service path for data flowing through a data communications service are disclosed. A set comprising a plurality of service modules is determined, wherein each service module corresponds to a functional task and wherein the set includes all of the functional tasks required to provide the desired data communications service. Ordering constraints associated with each of the service modules are determined, and a sequence for traversing the service modules is calculated, based on the ordering constraints.

### BACKGROUND

1. Technical Field

The present invention generally relates to configuring IP-based data services at a service provider site, and specifically relates to methods and apparatus for determining a sequence for traversing a plurality of service modules making up a desired data communications service based on ordering constraints associated with the service modules.

2. Background

As wireless telecommunications networks and the Internet continue to evolve, new multimedia services appear frequently. Service providers, which may include wireless network operators, are continuously challenged to rapidly deploy new or upgraded services.

Architectures for service platforms are also evolving rapidly. Modern architectures are increasingly modular in nature, facilitating the provision of common functions that may be reused by a variety of services supported by the service provider. One example of such an architecture is the IP Multimedia Subsystem (IMS) architecture defined by the 3^{rd} Generation Partnership Project (3GPP). On an IMS platform, some of the common functions that may be reused by several services include group/list management, presence, provisioning, operation and management, and many others.

Providing data services using modular service platform architectures enables an efficient deployment of platform resources. However, as multimedia services become more complex and more flexible, and as the service platforms become more modular, configuring a particular service becomes more complicated.

A given service may require that incoming data be processed by a sequence of service modules, where each service module performs a particular task. For example, a service platform providing voice-over-IP services may have separate service modules for transcoding, security, encryption and decryption, quality-of-service (QoS) classification, and so on. As the number of service modules involved in the service increases, the complexity of the configuration process also increases. This increased complexity in turn increases the probability that an error is made in the configuration, and generally slows the installation and deployment of new services.

### SUMMARY

Methods and apparatus for determining a service path for data flowing through a data communications service are disclosed. A set comprising a plurality of service modules is determined, wherein each service module corresponds to a functional task and wherein the set includes all of the functional tasks required to provide the desired data communications service. Ordering constraints associated with each of the service modules are determined, and a sequence for traversing the service modules is calculated, based on the ordering constraints.

Each ordering constraint may comprise a parameter indicating one or more input types that can be processed by the corresponding module, in which case the calculation of the sequence for traversing the service modules may comprise comparing the input types to output types associated with each of the plurality of service modules to determine an allowable order of traversal. Alternatively, an ordering constraint may comprise a parameter indicating one or more service modules that must precede the service module corresponding to the ordering constraint.

Performance data for one or more of the service modules may also be used in calculating the sequence for traversing the service modules. A sequence that optimizes a network performance parameter corresponding to the performance data is calculated, in view of the ordering constraints. Non-limiting examples of performance data are latency data, jitter data, and throughput data.

A configuration tool and processor for initializing a data communications service according to the previous methods are also disclosed.

### BRIEF DESCRIPTION OF THE DRAWINGS

FIG. 1 is a block diagram illustrating a service provider site bridging a wireless telecommunications network and the Internet.

FIG. 2 is a block diagram illustrating functional aspects of a service provider site.

FIG. 3 illustrates a sequence of service module functions arranged to provide a data communications service.

FIG. 4 is a table illustrating an association of ordering constraints with service modules.

FIG. 5 shows a flow diagram of a method for determining a service path for a data communications service in accordance with one or more embodiments of the invention.

FIG. 6 is a functional block diagram of a configuration tool for initializing a data communications service in accordance with one or more embodiments of the invention.

### DETAILED DESCRIPTION

It should be understood that the following description, while indicating several embodiments of the invention, is given by way of illustration only. Various changes and modifications within the scope of the invention will become apparent to those skilled in the art. Furthermore, although the invention is discussed below in the context of a wireless telecommunications network, those skilled in the art will appreciate that the methods and apparatus disclosed herein are applicable to data networks in general, and are in particular applicable to IP networks, whether encompassing wireless or fixed networks, or both.

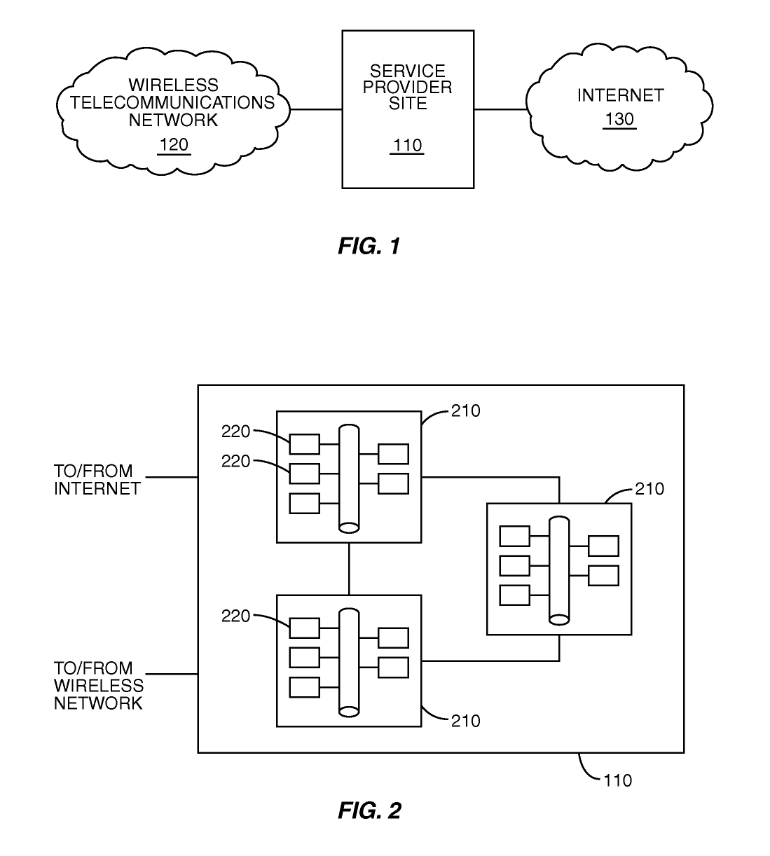

FIG. 1 illustrates an exemplary service provider site 110 connected to a wireless telecommunications network 120 and the Internet 130. Service provider site 110 may be operated, for example, by a wireless operator providing voice and data services to mobile telephone users. Those data services may include VoIP services, video conferencing, multimedia streaming, multimedia collaboration services, and the like. Although FIG. 1 depicts the service provider site 110 bridging the Internet 130 and the wireless telecommunications network 120, other sites may be connected directly only to the Internet 130, or only to the wireless telecommunications network 120. Still others may provide services only within a private network.

FIG. 2 is a simplified illustration of a service provider site 110. The server provider site includes a number of magazines 210, each magazine 210 carrying a number of service modules 220. A magazine 210 may be a blade enclosure housing several specialized blades and/or general-purpose blade servers. A blade in magazine 210 may carry several of the same type of service module 220, or may carry a variety of different types. A service provider site 110 may include several magazines 210, or may simply comprise a single magazine 210.

Each service module 220 is configured to perform a particular task, such as encryption, decryption, QoS classification, and so on. In some cases a service module 220 is implemented with special-purpose hardware. For example, bulk encryption and decryption operations require a tremendous number of processing cycles, and may thus be advantageously implemented with special-purpose hardware. Service modules 220 configured to provide switching or routing functions might also be implemented with special-purpose hardware. However, these and other service modules 220 may also be implemented with general-purpose computing hardware. Those skilled in the art will readily recognize the advantages and disadvantages of each approach.

Several service modules 220 may be duplicates, i.e., dedicated to the same function, in order to provide a desired capacity at the service site. In some cases a service module 220 may provide several distinct functions. For example, an “IPsec” (IP security) service module may provide distinct encryption, decryption, authentication, and integrity validation functions.

In order to provide maximum flexibility in configuring services, the service modules 220 are interconnected with a switching fabric (not shown). As used herein, the term “switching fabric” refers simply to the hardware and/or software mechanisms for providing configurable routing between the various service modules 220, recognizing that the service modules 220 may be implemented on separate magazines 210, or within a single magazine 210. (Indeed, several service modules 220 may be implemented as separate tasks on a single microprocessor.) Those skilled in the art will thus recognize that switching fabrics may include hardware switches, routers, shared memories, shared data buses, or a combination. In any event, the purpose of this switching fabric is to permit the routing of data from a given service module 220 to several other service modules 220. In this manner, complex services may be provided by chaining together a sequence of service modules 220, without re-configuring the hardware of service provider site 220.

Although the service modules 220 may be interconnected in such a way as to permit the routing of data to several service modules 220 in an arbitrary sequence, only certain sequences of service modules 220 will make sense in some cases. For example, a VoIP service connecting a wireless user with an Internet user may include a transcoder function to convert an audio format optimized for the wireless telecommunications network 120 to another audio format for the Internet 130. The service may also support encryption and decryption, so that voice calls remain confidential as they traverse the Internet 130. The encryption and decryption function may be performed by separate service modules 220. However, the transcoder function will operate only with unencrypted data. Accordingly, encrypted data received from the Internet user must be processed by the decryption service module before being routed to the transcoder function. Likewise, data bound for the Internet user must be transcoded at the transcoder service module before being routed to the encryption service module.

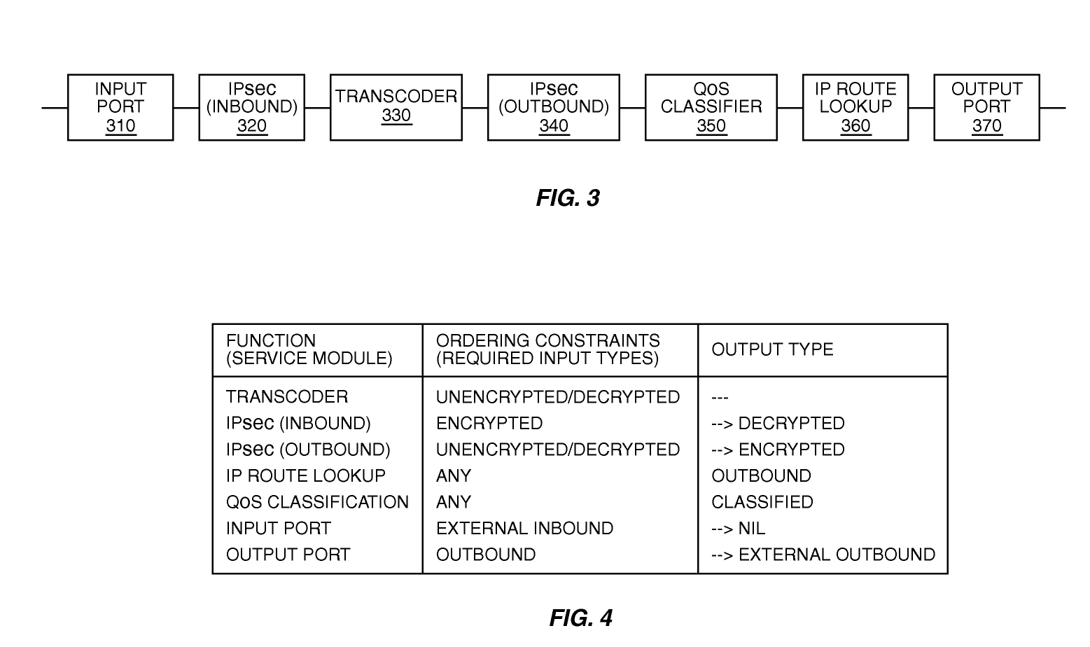

FIG. 3 illustrates a simplified service path for providing part of a transcoding service between a wireless application and an Internet application. Each of blocks 310-360 represent functions implemented by service modules 220. At block 310, incoming traffic from the Internet application is received and processed. Block 320 provides IPsec services, such as integrity validation, authentication, anti-replay protection, and decryption. Block 330 provides a transcoding function, converting audio data carried by incoming data packets from one audio format to another. Block 340 also provides IPsec services, which may be provided by the same service module 220 supporting block 320. Block 350 provides QoS classification, marking Internet-bound packets with a traffic descriptor for use in traffic policing and/or shaping. Block 360 provides IP route lookup services, after which outbound packets are routed to output port 370.

Those skilled in the art will recognize that several of the blocks in the service path illustrated in FIG. 3 are optional, depending, for example, on whether or not encryption is desired, or whether QoS classification is required. In addition, certain aspects of the sequence illustrated in FIG. 3 are fixed by the nature of the various service modules, while others are flexible. For example, as discussed earlier, if the incoming traffic is encrypted, then the transcoding function of block 330 must follow the decryption provided by block 320, since the transcoder cannot process encrypted data packets. However, QoS classification may be performed on any packet, encrypted or not. As a result, the QoS classification provided by block 350 could alternatively be provided before IPsec block 340, rather than after.

These sequencing-related characteristics of service modules 220 can be characterized in terms of “ordering constraints,” which implicitly or explicitly define a relationship between a given service module 220 and other service modules 220. These ordering constraints can be expressed in several different ways. For example, a simple ordering constraint might simply dictate that a particular service module 220 must be preceded by another specific module 220. For example, the service module 220 providing the transcoding services of block 330 might be associated with an ordering constraint dictating that it be preceded by a service module 220 providing the decryption function of block 340. Similarly, the service module 220 providing the output port function of block 370 might be associated with an ordering constraint dictating that it be preceded by the IP route lookup 360. Of course, some service modules 220, such as input port 310, might not require that they be preceded by a specific service module 220. Instead, the ordering constraint for input port 310 might specify that it be preceded by no service module 220 at all.

Ordering constraints might also be expressed in terms of “traffic types.” A traffic type describes an attribute of a data packet traversing the service provider site 110. Each service module 220 may modify the traffic type or types associated with a given packet. For example, the decryption function of block 320 will produce decrypted packets; these packets are designated a “decrypted” traffic type. The output of block 350 may be designated a “classified” traffic type. A given packet may have multiple traffic types; thus a packet that has traversed blocks 340 and 350 may be designated as a classified type as well as an encrypted type. In other words, a packet may accumulate several output types as it traverses the service path.

When data packets traversing service provider site 110 are typed in the preceding manner, then ordering constraints defining allowable (or required) input traffic types may be associated with each service module 220. For example, a service module 220 providing the transcoder function of block 330 might be associated with ordering constraints designating that only “decrypted” or “unencrypted” types are allowed as inputs. A service module 220 providing QoS classification, on the other hand, may be associated with an ordering constraint specifying that all traffic types are allowable inputs.

Once service modules 220 are associated with ordering constraints, provisioning of a new data service may be automated. A new service can initially be defined simply in terms of the needed functions, i.e., an un-ordered set of service modules 220. A sequencing of those functions is then automatically generated based on the ordering constraints.

The table in FIG. 4 provides an example of ordering constraints associated with each of the functions depicted in FIG. 3. The first table of the column lists each of the functions. This list is an unordered set of the service modules 220 required to carry out the overall service. Listed in the second column are output constraints associated with each of these functions/service modules. Here the ordering constraints are expressed in terms of required input types; as discussed above, other methods of expressing the ordering constraints are possible.

Finally, the third column lists the output type for data traffic exiting the service module 220. There are several different ways that a service module 220 can affect the output type. In some cases, the service module 220 has no effect on the output type. In this case, the output type remains the same as the input type. In FIG. 4, this is indicated by a “ - - - ” in the third column. In other cases, a service module 220 will add a type to the exiting traffic. For example, a QoS classification module might simply add the “Classified” type to exiting traffic, while the types attached to the traffic entering the module remain the same. Likewise, a service module 220 may remove a type from exiting traffic. This is illustrated in FIG. 4 with the Input Port function which removes the “External Inbound” type from incoming packets. Other types associated with the incoming packets, such as “Encrypted,” will remain undisturbed. Finally, a service module 220 might transform a type. This is seen in the case of the IPsec modules, which transform “Encrypted” types into “Decrypted” types and vice-versa.

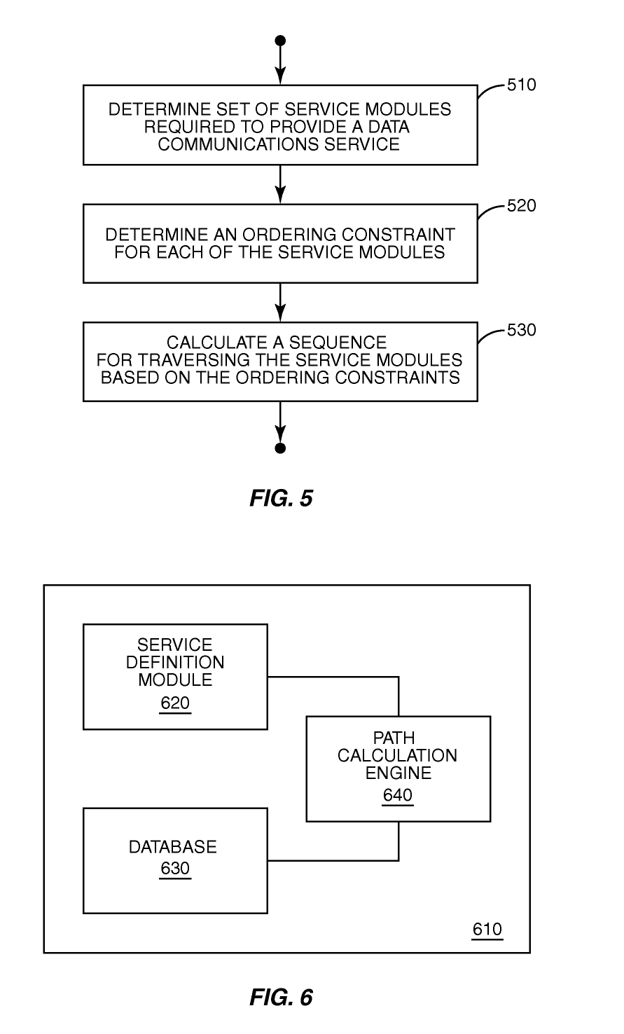

An examination of FIG. 4 reveals that the service module functions listed in the first column can readily be sequenced based on the ordering constraints and the output types. A process for determining a path for traversing the service modules 220 is illustrated in FIG. 5.

At block 510, a set of service modules 220 necessary for providing a data communications service is determined. This set of service modules 220 need not be ordered in any way. Rather, the output of this step is simply an unordered list of all of the functions required to implement the desired service.

Next, at block 520, ordering constraints for each of the service modules 220 in the set are determined. These ordering constraints may simply be retrieved from a database listing service module 220 functions and associated ordering constraints. In some cases, a service module 220 may have several functions, in which case the associated ordering constraints may be derived based on which of the several functions is to be used. For example, a particular service module 220 may be designed to support a variety of IPsec functions, such as encryption, decryption, authentication, and so on. For a given data communications service, only one of those functions might be selected. Therefore, only the ordering constraints associated with the selected function are needed; these ordering constraints may be selected from a database based on the selected function.

As discussed above, these ordering constraints may include parameters that indicate one or more input types that can be processed by the corresponding service module 220. Alternatively, the ordering constraints may specify that a given service module 220 must be preceded by another specific service module 220, or that it be preceded by no service module 220 at all. Those skilled in the art will recognize that other variations, or even combinations, of these ordering constraints are possible. For example, ordering constraints that specify service modules 220 that must follow a given service module 220 may apply to some service modules 220, while others are associated with ordering constraints that specify only an allowable input type.

Finally, at block 530, a sequence for traversing the service modules 220 is calculated, based on the ordering constraints. In the simplest approach, candidate sequences may be constructed systematically and analyzed for compliance with the ordering constraints, until a candidate sequence that satisfies all of the ordering constraints is found. Other, more sophisticated, approaches are also possible. Many of these approaches may be based on the mathematics of order theory. Algorithms applicable to advanced project scheduling may also be applied.

Determining that a particular sequence complies with the ordering constraints is generally a simple exercise, but the details depend on the type or types of ordering constraints used. When ordering constraints are defined as input types, then calculating the service path will include a comparison of the one or more input types allowed for a given service module 220 to the output types produced by preceding service modules 220. In other cases, such as where an ordering constraint specifies that a given service module 220 must be preceded by a particular service module 220, determining that a candidate sequence complies with the ordering constraints will include checking that the specified service module 220 does in fact appear first in the candidate service path.

The calculation of the service module traversal sequence may be based on factors in addition to the ordering constraints. For example, the order of traversal may in some cases affect the overall time required for data to traverse the entire system. In this case, the calculation of the sequence for traversing the service modules 220 may be based not only on the ordering constraints, but also on latencies associated with at least some of the service modules 220. For a service module 220 where the latency is affected by its placement in the service path, then performance data associated with the service module 220 will specify how the sequence affects the latency. Generally, the sequence yielding the lowest overall latency should be calculated, using this performance data

Similarly, the order of traversal might affect the overall processing cycles required. In this case, the calculation may be based on required processing power as well as on the ordering constraints. The resulting sequence should minimize the overall processing cycles required to provide the data communications service. Likewise, if other network traffic characterization parameters such as total throughput or jitter are affected by the service path sequence, then performance data corresponding to one or more service modules 220 may be defined to specify how the sequence affects those network parameters. The total throughput, total jitter, or other network parameter can thus be calculated for each candidate service path sequence. The service path that minimizes the total jitter or maximizes the total throughput, given the ordering constraints, can thus be determined.

FIG. 6 illustrates the functional components of a software-based configuration tool 610 for initializing a data communications service according to the previously described approaches. The configuration tool 610 comprises three components: a service definition module 620, a database 630, and a path calculation engine 640.

The service definition module 620 is configured to determine the set of service modules 220 required to implement a desired data communications service. Service definition module 620 may comprise a user interface (not shown), through which a service provider can select service modules 220 to build a list of required functions for a service. Service definition module 620 may also support macros, i.e. building blocks composed of several service modules 220, from which more complex services can be constructed.

Database 630 stores information relating to each of the available service modules 220, as well as the ordering constraints associated with each of the service modules 220. This information may also include performance data characterizing how network parameters such as latency, throughput, or jitter are affected by sequence.

The information in database 630, along with the set of service modules 220 determined by the service definition module, is used by the path calculation engine 640. Path calculation engine 640 calculates a sequence for traversing each service module 220 in the set determined by service definition module 620, based on the ordering constraints. If applicable, performance data retrieved from database 630 is also used in calculating the sequence, in which the calculation is also performed so as to optimize one or more network performance parameters corresponding to the performance data. As discussed above, a variety of algorithms may be employed by path calculation engine 640 to calculate permissible sequences for traversing the service modules 220. In addition, as described above, additional factors, such as latency or processing cycles, may be utilized by path calculation engine 640 in determining possible sequences.

Configuration tool 610 will often be linked directly to utilities for configuring the service modules 220, based on the sequence calculated by path calculation engine 640. In many cases, configuration tool 610 will be utilized infrequently, such as when a service provider deploys new services or service upgrades. However, configuration tool 610 is also suitable for dynamic application. In the extreme case, a data communications service may actually be defined by an end user on an as-needed basis, in which case configuration tool 610 is utilized to initialize the service on a per-user basis, and perhaps even on a per-use basis.

Configuration tool 610 may be implemented as software running on one or more processors of a general-purpose computer, and may be co-located with other service provisioning tools. The configuration tool 610 may be implemented as part of the service platform itself, or it may be implemented on a separate workstation. In some cases, access to configuration tool 610 may be restricted to certain service provider personnel, while in other cases, such as the on-demand service provisioning example discussed above, configuration tool 610 may be accessed via online tools for defining ad-hoc services.

The flowcharts and block diagrams described herein illustrate exemplary operations for determining a service path for data flowing through a data communications service, in accordance with various embodiments of the present invention. It will be understood that each block of the flowchart and block diagram illustrations, and combinations of blocks in the flowchart and block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the message flow, flowchart and/or block diagram block or blocks.

With these and other variations and extensions in mind, those skilled in the art will appreciate that the foregoing description and the accompanying drawings represent non-limiting examples of the methods and apparatus taught herein for determining a sequence for traversing service modules making up a desired data communications service based on ordering constraints associated with the service modules. As such, the present invention is not limited by the foregoing description and accompanying drawings. Instead, the present invention is limited only by the following claims and their legal equivalents.

What is claimed is:

1. A method of determining a service path for data flowing through a data communications service, comprising:
determining a set comprising a plurality of service modules, wherein each service module performs a functional task and wherein the set comprises all of the functional tasks required to provide the data communications service;
determining at least one ordering constraint for each of the plurality of service modules; and
calculating the service path as a sequence for traversing the service modules based on the ordering constraints.

2. The method of claim 1, wherein the at least one ordering constraint for one or more of the service modules comprises a parameter indicating one or more input types that can be processed by the corresponding service module.

3. The method of claim 2, wherein calculating the service path as a sequence for traversing the service modules comprises comparing the one or more input types to output types associated with each of the plurality of service modules to determine an allowable order of traversal.

4. The method of claim 1, wherein the at least one ordering constraint for one or more of the plurality of service modules comprises a parameter indicating one or more service modules that must precede the corresponding service module.

5. The method of claim 1, further comprising determining performance data for one or more of the service modules, wherein the performance data corresponds to a network performance parameter, and wherein calculating the service path as a sequence for traversing the service modules based on the ordering constraints further comprises calculating the sequence, based on the performance data, that optimizes the network performance parameter for the data communications service, given the ordering constraints.

6. The method of claim 5, wherein the performance data comprises latency data and the network performance parameter comprises a total latency, and wherein calculating the sequence comprises calculating the sequence that minimizes the total latency for the data communications service.

7. The method of claim 5, wherein the performance data comprises jitter data and the network performance parameter comprises a total jitter, and wherein calculating the sequence comprises calculating the sequence that minimizes the total jitter for the data communications service.

8. The method of claim 5, wherein the performance data comprises throughput data and the network performance parameter comprises a total throughput, and wherein calculating the sequence comprises calculating the sequence that maximizes the total throughput for the data communications service.

9. A configuration tool for initializing a data communications service, comprising:
a service definition module configured to determine a set comprising a plurality of service modules, wherein each service module performs a functional task and wherein the set comprises all of the functional tasks required to provide the data communications service;
a database comprising at least one ordering constraint for each of the plurality of service modules; and
a path calculation engine configured to calculate a sequence for data to traverse the service modules based on the ordering constraints.

10. The configuration tool of claim 9, wherein the path calculation engine is configured to compare one or more input types associated with a service module to output types associated with each of the plurality of service modules to determine an allowable order of traversal.

11. The configuration tool of claim 9, wherein the database comprises performance data for one or more service modules, the performance data corresponding to a network performance parameter, and wherein the path calculation engine is further configured to calculate the sequence, based on the performance data, that optimizes the network performance parameter for the data communications service, given the ordering constraints.

12. The configuration tool of claim 11, wherein the performance data comprises latency data and the network performance parameter comprises a total latency, and wherein the path calculation engine is configured to calculate the sequence that minimizes the total latency for the data communications service.

13. The configuration tool of claim 11, wherein the performance data comprises jitter data and the network performance parameter comprises a total jitter, and wherein the path calculation engine is configured to calculate the sequence that minimizes the total jitter for the data communications service.

14. The configuration tool of claim 11, wherein the performance data comprises throughput data and the network performance parameter comprises a total throughput, and wherein the path calculation engine is configured to calculate the sequence that maximizes the total throughput for the data communications service.

15. A processor configured to:
determine a set comprising a plurality of service modules, wherein each service module performs a functional task and wherein the set comprises all of the functional tasks required to provide a desired data communications service;
determine at least one ordering constraint for each of the plurality of service modules; and
calculate a service path for data to flow through the data communications service as a sequence for traversing the service modules based on the ordering constraints.

16. The processor of claim 15, further configured to determine performance data for one or more of the service modules, wherein the performance data corresponds to a network performance parameter, and wherein the processor is configured to calculate the sequence for traversing the service modules, based on the performance data, that optimizes the network performance parameter for the data communications service, given the ordering constraints.
